(19) United States
(12) Patent Application Publication
(10) Pub. No.: US 2026/0241987 A1
(43) Pub. Date: Aug. 20, 2026

(54) METHOD FOR CONTROLLING A REDUNDANT ACTUATOR WITH TWO PARTIAL ACTUATORS AND ACTUATOR SYSTEM WITH A REDUNDANT ACTUATOR HAVING TWO PARTIAL ACTUATORS

(71) Applicant: Schaeffler Technologies AG & Co. KG, Herzogenaurach (DE)

(72) Inventors: Rene Hopperdietzel, Nürnberg (DE); Nikolas Abt, Böblingen (DE); Artur Wieclawski, Herne (DE)

(73) Assignee: Schaeffler Technologies AG & Co. KG, Herzogenaurach (DE)

(21) Appl. No.: 19/164,198

(22) PCT Filed: Feb. 14, 2024
(86) PCT No.: PCT/DE2024/100123

§ 371 Date: Sep. 11, 2025

(30) Foreign Application Priority Data
Mar. 14, 2023 (DE) 10 2023 106 263.8

(51) Int. Cl. B62D 5/04

(52) U.S. Cl. CPC B62D 5/0484; B62D 5/0418; B62D 5/0487

(57) ABSTRACT

The disclosure relates to a method for controlling a redundant actuator having two partial actuators, by means of a control device. A first partial actuator is connected to a first actuator terminal of the control device and a second partial actuator is connected to a second actuator terminal of the control device. The control device includes a first, a second and a third converter module, each of which has a converter. In a first operating state the first actuator terminal is connected to the converter of the first converter module and the second actuator terminal is connected to the converter of the second converter module. A malfunction in the first converter module is identified and the control device transitions to an insulation state in which the first actuator terminal and the second actuator terminal are insulated from the converters of the first, second and third converter module.

### CROSS-REFERENCE TO RELATED APPLICATIONS

This application is the U.S. National Phase of PCT Application No. PCT/DE2024/100123 filed on Feb. 14, 2024, which claims priority to DE 10 2023 106 263.8 filed on Mar. 14, 2023, the entire disclosures of which are incorporated by reference herein.

### TECHNICAL FIELD

The disclosure relates to a method for controlling a redundant actuator having two partial actuators. Furthermore, the disclosure relates to an actuator system, in particular for a steer-by-wire system, having a redundant actuator having two partial actuators.

### BACKGROUND

The disclosure can be used in the field of automotive engineering, in particular in the area of steer-by-wire systems. With such steer-by-wire systems there is no mechanical connection between the steering wheel and the steered wheel. All steering commands are received by sensors on the steering wheel and transmitted electrically via a control unit to one or more steering actuators, which execute the steering movements and transmit them to the wheels. In addition to these steering actuators, such steer-by-wire systems usually have an actuator to provide a force-feedback torque on the steering wheel. Such force-feedback actuators can give the driver the same steering feel, or the same haptic feedback, that they are accustomed to from steering a vehicle with mechanically connected steering and power assistance.

An actuator system of the type mentioned at the outset is known from DE 10 2021 112 819 A1. This actuator system includes a redundant actuator that has two partial actuators and can be used, for example, as a force-feedback actuator. To control these redundant actuators, a control device is used which can control the two partial actuators. The control device comprises three converters, wherein one of the three converters can optionally replace one of the other two converters.

If a higher-level control unit is used to coordinate the individual converters, the disadvantage is that this requires additional installation space. In addition, precautions would have to be taken to ensure that such a higher-level control device is also designed redundantly in order to avoid a total failure of the actuator system in the event of a malfunction in the higher-level control device. Such measures can further increase the installation space requirements and costs.

### SUMMARY

Against this background, the object arises of enabling the coordination of redundant converter modules of the control unit with little effort and with little installation space requirement.

The object is achieved by a method for controlling a redundant actuator having two partial actuators, in particular a motor having two separate winding sets, by means of a control device,
wherein a first partial actuator is connected to a first actuator terminal of the control device and a second partial actuator is connected to a second actuator terminal of the control device,
wherein the control device comprises a first, a second and a third converter module, each of which has a converter,
wherein in a first operating state the first actuator terminal is connected to the converter of the first converter module and the second actuator terminal is connected to the converter of the second converter module,
wherein a malfunction in the first converter module is identified and the control device transitions to an insulation state in which the first actuator terminal and the second actuator terminal are insulated from the converters of the first, second and third converter modules,
wherein in the insulation state a handshake communication between the first, second and third converter modules of the control device takes place, wherein by means of handshake communication it is negotiated which of the converters of the converter modules is or are to be connected to the actuator terminals of the control device.

The method according to the disclosure provides a handshake communication between the first, second and third converter modules. If a malfunction is identified in a converter module—referred to here as the first converter module—in the first operating state, the control device is put into the insulation state—either automatically or manually by a user. In this state, all converters of the three converter modules are electrically insulated from the actuator terminals of the control device. In this respect, the redundant actuator is not controlled by the control device in the insulation state. In this insulation state, the handshake communication takes place between all three converter modules of the control device, wherein it is negotiated between the three converter modules which one or two converter modules or converters are connected to the actuator terminals of the control device after the insulation state has ended, so that the redundant actuator can then be operated despite the malfunction in one of the converter modules. Handshake communication makes it possible to do without a higher-level control unit and enables a modular design with independent converter modules. These measures enable the coordination of the control unit's converter modules with little effort and minimal space requirements.

According to an example embodiment, it is provided that the control device of the handshake communication subsequently transitions from the insulation state into a second operating state in which the actuator terminals are connected to the converter module or modules as negotiated by means of the handshake communication. This second operating state can form an operating state in which the redundant actuator is operated with identical function as in the first operating state. In the second operating state, however, the ability of the control device to compensate for further errors may be reduced or such error compensation may no longer be possible.

According to an example embodiment, it is provided that the malfunction is identified by the first converter module itself. The identified malfunction can be communicated from the first converter module to the other two converter modules.

According to an example embodiment, it is provided that each of the three converter modules monitors the respective other converter modules and identifies the malfunction in the first converter module. For example, it can be provided that the converter modules send regular, in particular periodic, signals to the respective other converter modules indicating that no malfunction is present. If such a signal is missing, the other converter modules can identify that there is a malfunction in the first converter module.

According to an example embodiment, it is provided that the handshake communication comprises:
a request step in which the first, second and third converter modules each check whether a request message has been received from the respective other, in particular all other, converter modules.

The request message allows a converter module to signal to the other converter modules that it intends to perform a handshake communication. Optionally, it can be provided that a timer with a specified runtime is started in the request step and subsequent steps of the handshake communication are only initiated when either the timer has elapsed or a request message has been received from all other converter modules.

According to an example embodiment, it is provided that the handshake communication comprises:
a status exchange step in which the first, second and third converter modules each determine status information of their operational readiness and transmit the determined status information to the respective other converter modules.

The operational readiness status information can indicate whether the respective converter module is ready for operation or not ready for operation, for example, if it is defective. Since the respective converter modules determine the status information themselves, determination by a higher-level device is not necessary. By exchanging status information between all converter modules, it can be ensured that all converter modules are aware of the operational status of each other. The exchange of status information is therefore a basis for deciding which converter modules or converters should be connected to the actuator terminals of the control device. The exchange can take place, for example, via separate data lines or a data bus. Since the status information available in the converter modules after completion of the status exchange step is identical in all converter modules, the subsequent decision can lead to the same result in all converter modules.

According to an example embodiment, it is provided that the handshake communication comprises:
a decision step in which the first and second converter modules each determine a command for the third converter module based on the status information received from the respective other converter modules and send it to the third converter module.

Based on the status information exchanged between the converter modules in the status exchange step, a decision can be made in the decision step as to which function the third converter module should assume. This decision can be made independently in the first and second converter modules and then a corresponding command is sent to the third converter module. If the commands received by the first and second converter modules are identical, the command can be easily implemented in the third converter module. If the commands received by the first and second converter modules differ, the third converter module decides separately and independently of the first and second converter modules which of the two commands it will implement. For example, it may be that both the first and the second converter module are not ready for operation and therefore the first converter module sends the command to the third converter module to take over the function of the first converter module and the second converter module sends the command to the third converter module to take over the function of the second converter module. In this case, the third converter module decides which function it will perform, preferably according to a predefined criterion.

According to an example embodiment, it is provided that the handshake communication comprises:
a confirmation step in which the third converter module sends a confirmation message to the first and second converter module.

The content of the confirmation message can depend on whether the third converter module has implemented the respective command of the first or second converter module or not. The respective confirmation message can be received by the first and the second converter module and evaluated in such a way that the first or second converter module implements its own corresponding procedure.

According to an example embodiment, it is provided that in the first operating state the actuator terminals of the control device are insulated from the converter of the third converter module. The third converter module can be in an inactive state. In this respect, the third converter module in such a design forms a cold reserve within the control device.

According to an example embodiment, it is provided that the partial actuators act on a common drive element, in particular a common drive shaft. The redundant actuator can be designed as a force-feedback actuator for providing a force-feedback torque on a steering wheel and/or actuator for adjusting a steering wheel position and/or as an actuator for transferring a steering wheel into a stowed position. According to an example embodiment, the redundant actuator is designed as an actuator on a tie rod.

According to an example embodiment, it is provided that the first, second and third converter modules each have a logic unit for controlling the converter. The converter can be designed as an inverter, in particular as a B6 inverter. In an example embodiment, the first and the second converter module each further comprise an output switching device by means of which a connection between the converter and an actuator terminal of the control device can be selectively established or interrupted. The third converter module can further include an output switching device by means of which a connection between the converter of the third converter module and one of the first and second actuator terminals of the control device can be selectively established or interrupted. In an example embodiment, the output switching device has bidirectionally blocking switches, in particular bidirectionally blocking semiconductor switches.

According to an example embodiment, it is provided that the control device has two supply network terminals. The supply network terminals can be connected to inputs of the converter modules via input switching devices. The first and the second converter module can each include an input switching device by means of which a connection between the converter module and a supply network terminal of the control device can be selectively established or interrupted. The third converter module can further include an input switching device by means of which a connection between the third converter module and one of the first and second supply network terminals of the control device can be selectively established or interrupted.

According to an example embodiment, it is provided that the first converter module and the second converter module are designed identically, in particular a handshake logic of the first and second converter module controlling the handshake communication is designed identically. The third converter module can have a converter which is designed identically to the respective power sections of the first and second converter modules. The third converter module can include a handshake logic that controls the handshake communication and is designed differently from the respective handshake logic of the first and second converter modules.

According to an example embodiment, it is provided that before each start of the overall system, a handshake communication takes place between the first, second and third converter modules of the control device, wherein the handshake communication is used to negotiate which of the converters of the converter modules is or are to be connected to the actuator terminals of the control device. This ensures that any malfunctions that occur or develop during the start-up phase lead to the selection of functional converter modules.

A further subject matter of the disclosure is an actuator system, in particular for a steer-by-wire system, having:
a redundant actuator having two partial actuators, in particular a motor having two separate winding sets, and
a control device for controlling the redundant actuator, wherein the control device comprises a first, a second and a third converter module, each having a converter, wherein the control device is configured:
   in a first operating state to connect the first actuator terminal to the converter of the first converter module and the second actuator terminal to the converter of the second converter module, and
   to identify a malfunction in the first converter module and to transition to an insulation state in which the first actuator terminal and the second actuator terminal are insulated from the converters of the first, second and third converter modules, in the insulation state to carry out a handshake communication between the first, second and third converter modules of the control device, wherein by means of the handshake communication it is negotiated which of the converters of the converter modules is or are connected to the actuator terminals of the control device.

The same advantages and technical effects can be achieved with the actuator system as have already been described above in connection with the method according to the disclosure.

According to an example embodiment, it is provided that the redundant actuator is designed as an actuator on a tie rod. According to an example embodiment of the actuator system, it is provided that the redundant actuator is designed as a force-feedback actuator for providing a force-feedback torque on a steering wheel and/or actuator for adjusting a steering wheel position and/or as an actuator for transferring a steering wheel into a stowed position.

Alternatively or additionally, the example embodiments and features described in connection with the method according to the disclosure can also be used in the actuator system according to the disclosure—individually or in combination.

### BRIEF DESCRIPTION OF THE DRAWINGS

Further details and advantages of the disclosure are explained below with reference to the example embodiment shown in the drawings. In the drawings:

FIG. 1 shows an example embodiment of a actuator system according to the disclosure in a schematic block diagram;

FIG. 2 shows an example embodiment of a control device of the actuator system according to FIG. 1;

FIG. 3 shows a flow chart of an example embodiment of a method according to the disclosure for operating an actuator system;

FIG. 4 is a flow diagram explaining the processes in the first and second converter modules during a handshake communication; and

FIG. 5 is a flow diagram explaining the processes in the third converter module during a handshake communication.

### DETAILED DESCRIPTION

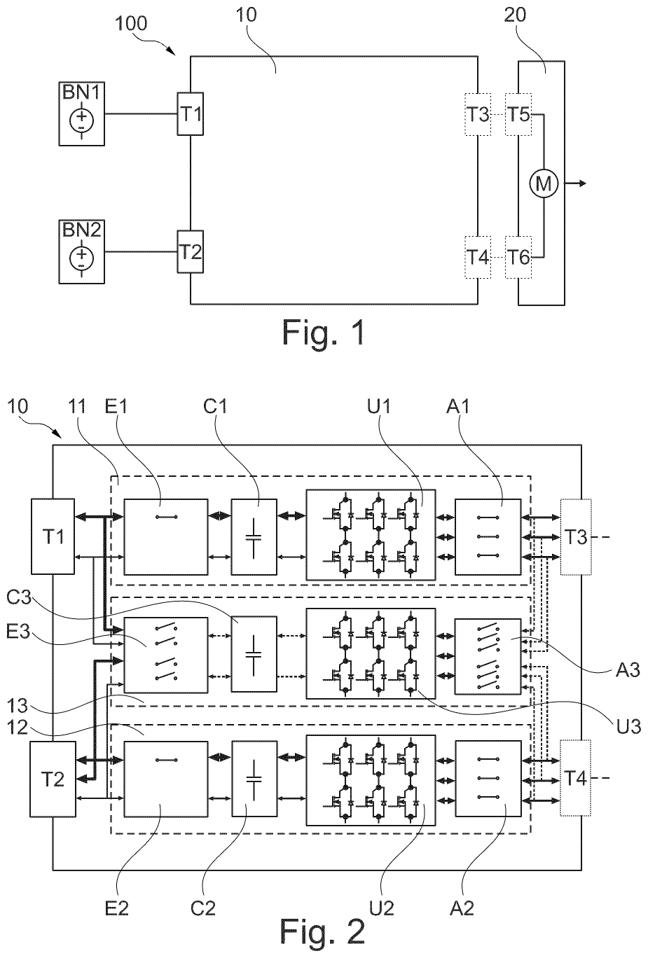

FIG. 1 shows an exemplary embodiment of an actuator system 100 having a redundant actuator 20 and a control device 10 for controlling the actuator 20 in a block diagram. The actuator system 100 comprises a redundant actuator 20, which in the exemplary embodiment is designed as an electric motor having two separate winding sets. The separate winding sets each form a partial actuator of the redundant actuator 20 and can be controlled independently of one another. The actuator system 100 can be configured for use in a steer-by-wire system. In this case, the actuator 20 is an actuator on a tie rod. Alternatively, the actuator 20 can be a force-feedback actuator for providing a force-feedback torque on a steering wheel of the steer-by-wire system.

The control device 10 is connected to two independent or partially independent supply networks BN1, BN2. When using the actuator system 100 in a steer-by-wire system, the two supply networks 1, 2 can be designed as DC voltage on-board networks of a vehicle. To connect the control device 10 to the two on-board networks, the control device 10 comprises a first supply network terminal T1 and a second supply network terminal T2.

The control device 10 further comprises a first actuator terminal T3 and a second actuator terminal T4, via which the control device 10 is connected to the redundant actuator 20. The first actuator terminal T3 is connected to the first partial actuator via a first terminal T5 of the actuator 20 and the second actuator terminal T4 is connected to the second partial actuator via a second terminal T6 of the actuator 20. In the exemplary embodiment, both partial actuators act on a common drive element, for example a common drive shaft.

As can be seen in the detailed representation of the control device 10 in FIG. 2, the first actuator terminal T3 and the second actuator terminal T4 are multi-phase, here three-phase.

The control device 10 comprises a total of three converter modules 11, 12, 13, each of which has an input switching device E1, E2, E3, a buffer capacitor C1, C2, C3, a converter U1, U2, U3, and an output switching device A1, A2, A3. A further component of the converter modules 11, 12, 13 is a logic unit (not shown in the drawings) for controlling the functions of the respective converter module 11, 12, 13, in particular the respective input switching device E1, E2, E3, the respective converter U1, U2, U3, and the respective output switching device A1, A2, A3.

According to the illustration in FIG. 2, the control device 10 is in a first operating state in which the first actuator terminal T3 is connected to the converter U1 of the first converter module 11 and the second actuator terminal T4 is connected to the converter U2 of the second converter module 12. To connect the converter U1 of the first converter module 11 to the first actuator terminal T3, the output switching device A1 of the first converter module 11 is placed in a conductive state. Likewise, the output switching device A2 of the second converter module 12 for connecting the converter U2 of the second converter module 12 to the second actuator terminal T4 is in a conductive state. The output switching device A3 of the third converter module, however, insulates the converter U3 of the third converter module 13 from the actuator terminals T3, T4.

On the input side, in the first operating state, the input switching devices E1, E2 of the first and second converter modules 11, 12 are in a conductive state and the input switching device E3 of the third converter module 13 is in an insulating state.

In the first operating state, the first partial actuator of the redundant actuator 10 is controlled by the first converter module 11 of the control device 10 and the second partial actuator via the second converter module 12 of the control device 10.

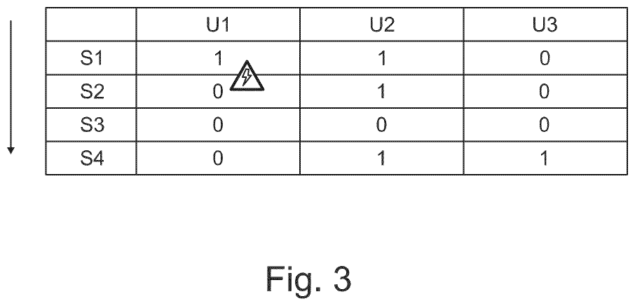

FIG. 3 shows a flow chart of an example embodiment of a method according to the disclosure for operating an actuator system, wherein for the states
first operating state S1,
fault operating state S2,
insulation state S3, and
second operating state S4
   it is indicated whether the respective converters U1, U2, U3 of the converter modules 11, 12, 13 are connected to an actuator terminal T3, T4 and are active (=1), are not connected to an actuator terminal T3, T4 and are inactive (=0) or are connected to an actuator terminal T3, T4 and at the same time a malfunction is identified in the respective converter module 11, 12, 13 (=lightning symbol).

In the first operating state S1, the first actuator terminal T3 is connected to the converter U1 of the first converter module 11 and the second actuator terminal T4 is connected to the converter U2 of the second converter module 12. In addition, the converter U3 of the third converter module 13 is in a switched-off, inactive state.

If a malfunction is identified in the first converter module 11 in the first operating state S1, the first converter module 11 goes into a non-active state in which the converter U1 of the first converter module 11 is insulated from the actuator terminals T3, T4. The fault operating state S2 exists, in which the second converter module 12 is still active and the third converter module 13 is not active.

Upon identification of the malfunction in the first converter module 11, the control device does not remain in the fault operating state S2 but is placed—either automatically or manually by a user—in the insulation state S3, in which the first actuator terminal T3 and the second actuator terminal T4 are insulated from the converters U1, U2, U3 of the first, second and third converter modules 11, 12, 13. In this respect, all converter modules 11, 12, 13 are not active.

In this insulation state S3, a handshake communication takes place between the first, second and third converter modules 11, 12, 13, wherein the handshake communication is used to negotiate which of the converters U1, U2, U3 of the converter modules 11, 12, 13 is or are to be connected to the actuator terminals T3, T4 of the control device 10 following the insulation state S3.

After completion of the handshake communication in the insulation state S3, the control device 10 then transitions from the insulation state S3 to a second operating state S4, in which the actuator terminals T3, T4 are connected to the converter or converters U1, U2, U3 of the converter modules 11, 12, 13 as negotiated by means of the handshake communication. In the case shown in FIG. 3, the second and third converter modules 12, 13 are active in the second operating state. The converter U2 of the second converter module is connected to the second actuator output T4, and the converter U3 of the third converter module 13 is connected to the first actuator output T3. In this respect, the third converter module 13 in the second operating state S4 takes over the function which the first converter module 11 had in the first operating state.

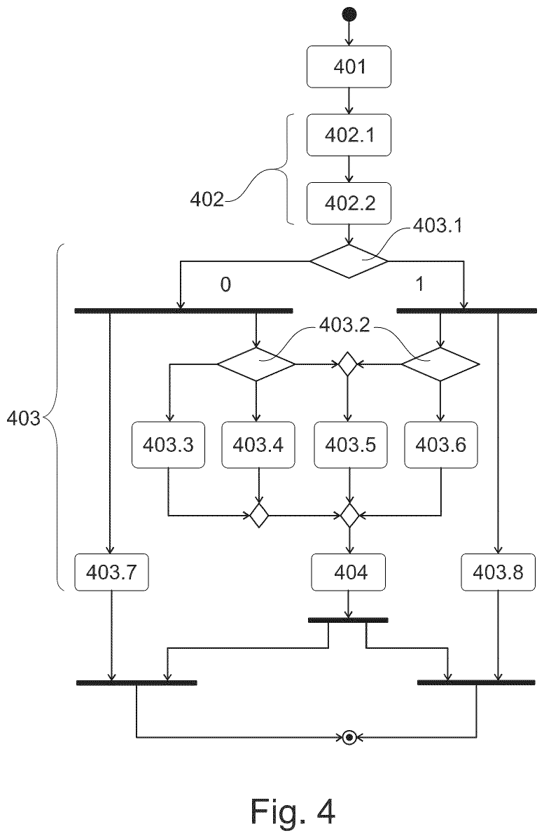

FIG. 4 shows a flow diagram to explain the processes in the first and second converter modules 11, 12 during a handshake communication.

According to this example embodiment, the handshake communication begins with a request step 401, in which the first and second converter modules each check whether a request message has been received from the respective other converter modules. The first and second converter modules 11, 12 remain in the request step 401 until corresponding request messages from the other two converter modules 11, 12, 13 have been received. Optionally, it can be provided that a timer with a specified runtime is started in the request step 401 and subsequent steps of the handshake communication are only initiated when either the timer has elapsed or a request message has been received from all other converter modules 11, 12, 13.

The request step 401 is basically optional, so that in a modification of the example embodiment it can be omitted.

In a status exchange step 402 following the request step 401, the first and second converter modules 11, 12 each determine their operational readiness and transmit corresponding status information to the respective other converter modules 11, 12, 13. The status exchange step 402 is divided into a first sub-step 402.1 for determining the status and a second sub-step 402.2 for exchanging the status information. The operational readiness status information indicates whether the respective converter module 11, 12 is operational or not operational, for example defective.

In a decision step 403 following the status exchange step 402, the status information received from the other converter modules 11, 12, 13 is evaluated together with its own status information. The decision step 403 comprises a first test step 403.1 to check its own operational readiness and a second test step 403.2 to check the operational readiness of the other two converter modules 11, 12, 13.

Depending on the result of the first test step 403.1, i.e., depending on its own operational readiness, the respective converter module 11, 12 is then either deactivated or remains activated. For example, the converter module 11, 12 is deactivated (step 403.7) if the converter module 11, 12 is not ready for operation (=0) and kept active if it is ready for operation (=1) (step 403.8).

Depending on the result of the second test step 403.2, i.e., additionally depending on the status information of the other converter modules 11, 12, 13, a command for the third converter module 13 is determined and sent to the third converter module 13. With regard to the first converter module 11, this means, for example, that if the first converter module 11 is not ready for operation and both other converter modules 12, 13 are ready for operation, the third converter module 13 is commanded to replace the first converter module 11 (step 403.3). If the first converter module 11 is not ready for operation and the second converter module 12 is also not ready for operation, the third converter module 13 is commanded to replace either the first or the second converter module 11, 12 (step 403.4). If the first and third converter modules 11, 13 are ready for operation and the second converter module 12 is not ready for operation, the third converter module 13 is commanded to replace the second converter module 12 (step 403.6). In all other cases (the third converter module 13 is not ready for operation or both the first and second converter modules 11, 12 are ready for operation), the third converter module is commanded to remain inactive according to step 403.5.

In a confirmation step 404 following the decision step 403, the third converter module 13 sends a confirmation message to the first and second converter modules 11, 12. The content of the confirmation message is whether the third converter module 13 has implemented the respective command of the first or second converter module 11, 12 or not. The respective confirmation message can be received by the first and second converter modules 11, 12 and evaluated in such a way that the first or second converter module 11, 12 implements its own corresponding procedure.

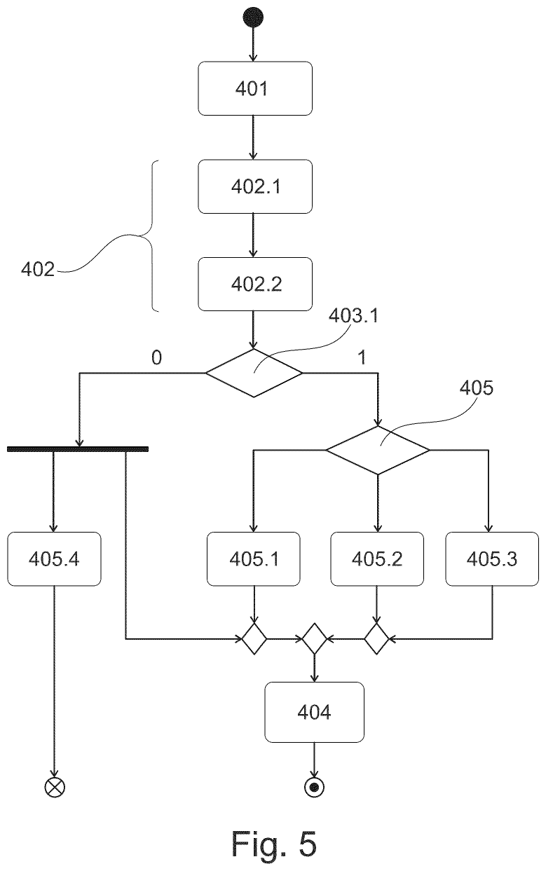

FIG. 5 shows a flow diagram to explain the processes in the third converter module 13 during a handshake communication. In principle, the processes in the third converter module 13 are similar to those in the first and second converter modules 11, 12. However, due to the fact that the third converter module can be connected to either the first or second or no actuator output T3, T4, there are some differences which are explained below.

According to this example embodiment, the handshake communication begins with a request step 401, in which the third converter module 13 checks whether a request message has been received from the respective other converter modules 11, 12. The third converter module 13 remains in the request step 401 until corresponding request messages from the other two converter modules 11, 12 have been received. Optionally, it can be provided that a timer with a specified runtime is started in the request step 401 and subsequent steps of the handshake communication are only initiated when either the timer has elapsed or a request message has been received from all other converter modules 11, 12.

The request step 401 is basically optional, so that in a modification of the example embodiment it can be omitted.

In a status exchange step 402 following the request step 401, the third converter module 13 determines its operational readiness and transmits corresponding status information to the other converter modules 11, 12. The status exchange step 402 is divided into a first sub-step 402.1 for determining the status and a second sub-step 402.2 for exchanging the status information. The operational readiness status information indicates whether the respective converter module 11, 12 is operational or not operational, for example defective.

Depending on the result of a test step 403.1, i.e., depending on its own operational readiness, the third converter module 13 is then either deactivated (step 405.4), or the commands of the other two converter modules 11, 12 are evaluated in a second test step 405. For example, the third converter module 13 is deactivated according to a corresponding command from the other two converter modules 11, 12 (step 405.1), replaces the first converter module 11 (step 405.2) or replaces the second converter module 12 (step 405.3). An exception is the situation when both the first and the second converter module 11, 13 are not ready for operation and therefore command the third converter module to replace both the first and the second converter module. In this case, the third converter module 13 decides which converter module it will replace according to a predetermined criterion.

Finally, in the confirmation step 404, the third converter module 13 sends a confirmation message to the first and second converter modules 11, 12. The content of the confirmation message is whether the third converter module 13 has implemented the respective command of the first or second converter module 11, 12 or not.

### LIST OF REFERENCE SYMBOLS

10 Control device
11 First converter module
12 Second converter module
13 Third converter module
20 Actuator
100 Actuator system
401 Request step
402 Status exchange step
402.1 Sub-step
402.2 Sub-step
403 Decision step
403.1 Test step
403.2 Test step
403.3 Step: Command to replace first converter module
403.4 Step: Command to replace first or second converter module
403.5 Step: Command to remain inactive
403.6 Step: Command to replace second converter module
403.7 Step: First converter module deactivated
403.8 Step: First converter module active
404 Confirmation step
405 Test step
405.1 Step: Third converter module deactivated
405.2 Step: Third converter module replaces first converter module
405.3 Step: Third converter module replaces second converter module
405.3 Step: Third converter module deactivated
A1 Output switching device
A2 Output switching device
A3 Output switching device
BN1 Supply network
BN2 Supply network
C1 Buffer capacity
C2 Buffer capacity
C3 Buffer capacity
E1 Input switching device
E2 Input switching device
E3 Input switching device
S1 First operating state
S2 Fault operating state
S3 Insulation state
S4 Second operating state
T1 Supply network terminal
T2 Supply network terminal
T3 Actuator terminal
T4 Actuator terminal
T5 Terminal of the actuator
T6 Terminal of the actuator
U1 Converter
U2 Converter
U3 Converter

1. A method for controlling a redundant actuator having two partial actuators, in particular a motor having two separate winding sets, via a control device, the method comprising:
providing a control device comprising:
a first actuator terminal connected to a first one of the two partial actuators,
a second actuator terminal connected to a second one of the two partial actuators,
a first converter module having a first converter,
a second converter module having a second converter, and
a third converter module, having a third converter,
wherein connecting, in a first operating state: i) the first actuator terminal to the first converter and ii) the second actuator terminal to the second converter, and
when a malfunction in the first converter module is identified, transitioning the control device to an insulation state in which: i) the first actuator terminal and the second actuator terminal are insulated from the first, second, and third converters and ii) a handshake communication between the first, second and third converter modules occurs, such that via the handshake communication, negotiation of which of the first, second, and third converters of the first, second, and third converter modules is or are to be connected to the first and second actuator terminals of the control device occurs.

2. The method according to claim 1, further comprising transitioning the control device during the handshake communication from the insulation state into a second operating state in which the first and second actuator terminals are connected to the first, second, and third converters of the first, second, and third converter modules as negotiated via the handshake communication.

3. The method according to claim 1, wherein the malfunction in the first converter module is identified by the first converter module.

4. The method according to claim 1, wherein each one of the three first, second, and third converter modules monitors the respective other of the first, second, and third converter modules and identifies the malfunction in the first converter module.

5. The method according to claim 1, wherein the handshake communication comprises a request step in which the first, second and third converter modules each check whether a request message has been received from the respective other of the first, second, and third converter modules.

6. The method according to claim 1, wherein the handshake communication comprises a status exchange step in which the first, second and third converter modules each determine status information of their operational readiness and transmit the determined status information to the respective other of the first, second, and third converter modules.

7. The method according to claim 6, wherein the handshake communication comprises a decision step in which the first and second converter modules each determine a command for the third converter module based on status information received from the respective other of the first, second, and third converter modules and send it to the third converter module.

8. The method according to claim 7, wherein the handshake communication comprises a confirmation step in which the third converter module sends a confirmation message to the first and second converter modules.

9. The method according to claim 1, wherein in the first operating state, the first and second actuator terminals of the control device are insulated from the third converter of the third converter module.

10. The method according to claim 1, wherein the first and second partial actuators act on a common drive shaft.

11. The method according to claim 1, wherein the first, second and third converter modules each have a logic unit for controlling the respective first, second, and third converters.

12. The method according to claim 1, wherein the control device has two supply network terminals.

13. The method according to claim 1, wherein the first converter module and the second converter module are identical.

14. An actuator system for a steer-by-wire system, having a redundant actuator with two partial actuators, in particular a motor having two separate winding sets, and having a control device for controlling the redundant actuator, and the control device comprises a first, a second and a third converter module, having a respective first, second, and third converter, wherein the control device is configured:
in a first operating state, to connect: i) a first actuator terminal to the first converter of the first converter module, and ii) a second actuator terminal to the second converter of the second converter module,
to identify a malfunction in the first converter module and to transition to an insulation state in which the first actuator terminal and the second actuator terminal are insulated from the first, second, and third converters of the first, second and third converter modules, and
in the insulation state, to carry out a handshake communication between the first, second and third converter modules of the control device wherein via means of the handshake communication it is negotiated which of the first, second, and third converters of the first, second, and third converter modules is or are connected to the first and second actuator terminals of the control device.

15. The actuator system according to claim 14, wherein the redundant actuator is an actuator on a tie rod of a steer-by-wire system.

16. The method according to claim 1, wherein a handshake logic of the first converter module is identical to a handshake logic of the second converter module.
